(19) United States
(12) Patent Application Publication
(10) Pub. No.: US 2025/0029515 A1
(43) Pub. Date: Jan. 23, 2025

(54) IMAGE PROCESSING APPARATUS THAT PRESENTS CONTENTS OF INPUT IMAGE IN STATE RECOGNIZABLE THROUGH TACTILE SENSATION, METHOD OF CONTROLLING SAME, IMAGE INFORMATION-PRESENTING APPARATUS, IMAGE INFORMATION-PRESENTING SYSTEM, AND STORAGE MEDIUM

(71) Applicant: CANON KABUSHIKI KAISHA, Tokyo (JP)

(72) Inventors: Toru AIDA, Tokyo (JP); Yasushi OHWA, Tokyo (JP)

(21) Appl. No.: 18/765,400

(22) Filed: Jul. 8, 2024

(30) Foreign Application Priority Data
Jul. 19, 2023 (JP) 2023-117391

(51) Int. Cl. G09B 21/00

(52) U.S. Cl. CPC G09B 21/003; G09B 21/006; G09B 21/007

(57) ABSTRACT

An image processing apparatus that presents contents of an input image, such as a photograph, such that a visually handicapped person can grasp the input image through tactile sensation. The image processing apparatus includes an image input section configured to input image data, a detection section configured to detect object types of objects and object areas of the objects based on the image data input by the image input section, and a presentation form determination section configured to determine a presentation form of presenting a tactile presentation area corresponding to each object area detected by the detection section, on an object type-by-object type basis.

### BACKGROUND OF THE INVENTION

### Field of the Invention

The present invention relates to an image processing apparatus that presents contents of an input image in a state recognizable through tactile sensation, a method of controlling the image processing apparatus, an image information-presenting apparatus, an image information-presenting system, and a storage medium.

### Description of the Related Art

A presentation device that presents tactile sensation with respect to e.g. text, a figure, and unevenness of a pattern, by independently moving up and down each of a plurality of pins, which are two-dimensionally arranged, in accordance with e.g. the text, figure, and unevenness of the pattern, displayed on a screen of a personal computer, has been proposed and is used by visually handicapped persons and the like. This presentation device is referred to as the pin display.

Further, there has been proposed a presentation device that presents warm and cold sensation with respect to e.g. the text, figure, and unevenness of the pattern, by electrically controlling semiconductor thermoelectric elements referred to as the Peltier elements, which are two-dimensionally arranged, to generate heat in accordance with e.g. the text, figure, and unevenness of the pattern, displayed on a screen of a personal computer. This presentation device is also used by the visual handicapped persons and the like and is referred to as the temperature sensation display (See Thermo Drawing: Development of a Thermal drawing system using portable tactile interactive thermal display; Information Processing Society of Japan (IPSJ) Interaction pp. 723-728 (2012), written by Kumiko Kushiyama, Kouki Doi, Shinji Sasada, and Tetsuaki Baba).

Further, in a case where image data, such as a photograph, is presented to a visually handicapped person, the following display is sometimes used in place of a display, such as a PC monitor, a smartphone, or a TV, used by a visually normal person (sighted person): For example, this is a case where a tactile display is used to recognize image data through tactile sensation in place of a device, such as a PC monitor, a smartphone, and a TV.

However, the above-mentioned tactile display is far from presentation of tactile sensation suitable for e.g. photograph appreciation to a visually handicapped person. To overcome this problem, there is a method of generating e.g. a photograph having unevenness and presenting this photograph through tactile sensation, but a lot of time and labor are required to provide the unevenness on image data, which increases the costs. Further, the amount of information of a photograph or the like is large to begin with, and hence if the information is expressed directly as the unevenness, the unevenness forms noise and sometimes interferes with photograph appreciation. For example, in a case where a color photograph having unevenness is generated, it also requires time and labor to discuss with a visually handicapped person every time to determine a location where unevenness is formed.

### SUMMARY OF THE INVENTION

The present invention provides an image processing apparatus that presents contents of an input image, such as a photograph, such that a visually handicapped person can grasp the input image through tactile sensation, a method of controlling the image processing apparatus, an image information-presenting apparatus, an image information-presenting system, and a storage medium.

In a first aspect of the present invention, there is provided an image processing apparatus including an image input section configured to input image data, a detection section configured to detect object types of objects and object areas of the objects based on the image data input by the image input section, and a presentation form determination section configured to determine a presentation form of presenting a tactile presentation area corresponding to each object area detected by the detection section, for each object type detected by the detection section.

In a second aspect of the present invention, there is provided an image processing apparatus including an image input section configured to input image data, a distance acquisition section configured to acquire distance information based on image data input by the image input section, and a presentation form determination section configured to determine a presentation form of presenting a tactile presentation area on a distance-by-distance basis, based on the distance information acquired by the distance acquisition section.

According to the present invention, it is possible to provide an image processing apparatus that presents contents of an input image, such as a photograph, such that a visually handicapped person can grasp the input image through tactile sensation, a method of controlling the image processing apparatus, an image information-presenting apparatus, an image information-presenting system, and a storage medium.

Further features of the present invention will become apparent from the following description of exemplary embodiments (with reference to the attached drawings).

### BRIEF DESCRIPTION OF THE DRAWINGS

FIG. 1 is a block diagram of an image information-presenting apparatus according to a first embodiment of the present invention.

FIG. 2 is a flowchart of an object/area detection process for detecting an object and an area, which is performed by the image information-presenting apparatus according to the first embodiment.

FIG. 3 is a flowchart of a tactile presentation process performed by the image information-presenting apparatus according to the first embodiment.

FIGS. 4A to 4F are diagrams useful in explaining input and output images in the first embodiment.

FIG. 5 is a flowchart of an object/area detection process for detecting an object and an area, which is performed by the image information-presenting apparatus according to a second embodiment of the present invention.

FIG. 6 is a flowchart of a tactile presentation process performed by the image information-presenting apparatus according to the second embodiment.

FIG. 7 is a flowchart of an object/area detection process for detecting an object and an area, which is performed by the image information-presenting apparatus according to a third embodiment of the present invention.

FIG. 8 is a flowchart of a tactile presentation process performed by the image information-presenting apparatus according to the third embodiment.

### DESCRIPTION OF THE EMBODIMENTS

The present invention will now be described in detail below with reference to the accompanying drawings showing embodiments thereof. However, the configuration described in the following embodiments is given only by way of example, and is by no means intended to limit the scope of the present invention. Further, in this specification, a tactile sensation is used as the meaning of a variety of senses generated when a hand touches an object. Further, a warm and cold sensation is used as the meaning of a sensation felt by a hand, such as hot and cold feelings, and unevenness feeling is used as the meaning of feeling of unevenness, which is felt by a hand. Therefore, the tactile sensation includes the warm and cold sensation and the unevenness feeling.

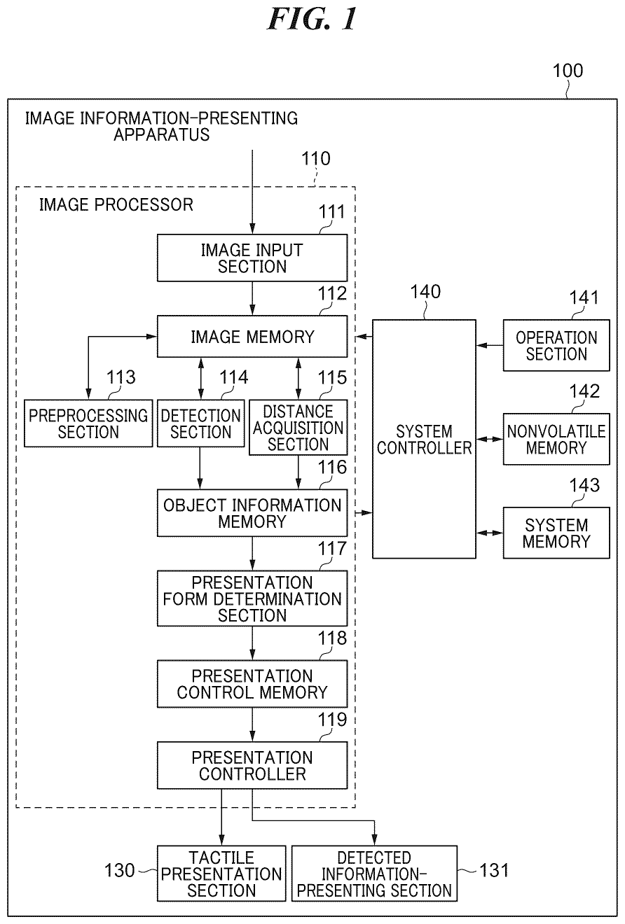

FIG. 1 is a block diagram of an image information-presenting apparatus 100 according to a first embodiments of the present invention. The image information-presenting apparatus 100 includes an image processor 110, a tactile presentation section 130, a detected information-presenting section 131, a system controller 140, an operation section 141, a nonvolatile memory 142, and a system memory 143. Further, the image processor 110 includes an image input section 111, an image memory 112, a preprocessing section 113, a detection section 114, a distance acquisition section 115, an object information memory 116, a presentation form determination section 117, a presentation control memory 118, and a presentation controller 119.

The detection section 114 detects e.g. an object type and an object area based on image data input by an image input section 111. A distance acquisition section 115 acquires an object distance (distance between the image processor 110 and an object) based on the image data. Further, the tactile presentation section 130 presents e.g. an object area on an object type-by-object type basis. Furthermore, the tactile presentation section 130 presents e.g. an object area for each object distance and each object type. More specifically, according to operation control by the presentation controller 119, the tactile presentation section 130 present information in a state recognizable through tactile sensation by controlling a displacement amount of each pin of a pin display according to a presentation form determined by the presentation form determination section 117. The same information presentation is performed by controlling the temperature of each Peltier element of a temperature sensation display according to a presentation form determined by the presentation form determination section 117. The detected information-presenting section 131 presents information of the same contents by using a braille display and/or voice

The image input section 111 includes an interface (I/F) for inputting digital image data. The image input section 111 has e.g. a high-definition multimedia interface (HDMI) (registered trademark) terminal as the interface and executes processing for receiving video signals conforming to the HDMI standard, extracting image data from the received video signals, and writing the extracted image data into the image memory 112. Further, the image input section 111 can be configured to include a physical I/F into which and from which a memory card capable of writing and reading high resolution image data at high speed, such as a secure digital (SD) card or a compact flash (CF) express card, can be inserted and removed. In this case, the image input section 111 reads image data recorded in a memory card inserted therein and writes the read image data into the image memory 112.

The image memory 112 is implemented e.g. by a semiconductor memory, such as a dynamic random-access memory (DRAM) or a static random-access memory (SRAM), and stores image data input by the image input section 111. The preprocessing section 113 reads out the image data stored in the image memory 112. The preprocessing section 113 executes optimum image processing on the read image data so as to perform processing in the detection section 114 and the distance acquisition section 115, and writes the image data subjected to the optimum image processing in the image memory 112. Here, the optimum image processing refers to, in a case where the image data is formed e.g. by YUV signals, gamma correction processing, shading processing, and white balance correction processing which are performed on the YUV signals. Further, not only these correction processing operations, but also noise reduction processing, resizing processing, and/or the like can be executed.

The detection section 114 reads out image data stored in the image memory 112 and detects one or more predetermined areas of objects from the read image data. The detection section 114 detects a position of the object, a size of the object, a type of the object (such as a vehicle, an airplane, a bird, an insect, a human body, a head, a pupil, a cat, a dog, or a ball), an area of the object, and so forth in the image data. The detection section 114 writes object data in which a position of the object, a size of the object, a type of the object, and a reliability of each type, and so forth in the image data are associated with each detected object area, in the object information memory 116.

The detection section 114 detects a candidate area using a known technique for detecting a feature area, such as a face area of a person or an animal. For example, the detection section 114 can be configured as a learned class discriminator using learning data. An algorithm used for discrimination (classification) is not particularly limited. The detection section 114 can be realized by causing a discriminator equipped with e.g. multi-class logistic regression, support vector machine, random forest, or neural network to perform learning. Further, the detection section 114 writes map information generated by mapping areas of objects occupying image data, and a type of each area (such as the sky, a human skin, and lawn grass), into the object information memory 116 as area data for each detected object area.

The distance acquisition section 115 reads out image data stored in the image memory 112 and estimates a distance from each object based on the read image data. As distance information, a distance map generated by converting the distance information related to each pixel into map data is written into the object information memory 116. For estimation of the distance, it is possible to use a known technique using e.g. a learned neural network. Not only this, but a variety of methods of estimating a distance from an image have been proposed. As the method of estimating an object distance, the distance acquisition section 115 can use any other method insofar as it can estimate a distance. Note that in a case where the distance information is input with image data beforehand, a distance map can be generated based on the input distance information.

The object information memory 116 is realized by a storage device, such as a random-access memory (RAM), and stores e.g. information detected by the detection section 114 and distance information acquired by the distance acquisition section 115.

The presentation form determination section 117 determines a presentation form in a tactile presentation area corresponding to an area occupied by an object of each object type detected by the detection section 114 and writes the determined presentation form in the presentation control memory 118, described hereinafter, based on an instruction from the system controller 140, described hereinafter. In doing this, the presentation form determination section 117 writes a variety of detected information (such as an object type, the number of detected objects, the detected position (coordinates) of an object, and an object detection area) in the tactile presentation area into the presentation control memory 118, described hereinafter, together.

Although the presentation form will be described hereinafter, the presentation form includes a form of presenting image information of each type of an object, a form of presenting image information of each distance and each type of an object, and a form of presenting image information of each distance. The presentation determination section 117 further determines a presentation form according to a type of a tactile presentation device (such as a pin display and a temperature sensation display) to be used.

In a case where the tactile presentation device is a pin display, the presentation determination section 117 determines a pin displacement amount according to an area of each object to be presented. The pin displacement amount in the area of each object can be determined according to the resolution of the pin displacement amount as desired. The displacement amount of pins corresponding to an object area can be set, for example, to the maximum displacement amount or to the minimum displacement amount of pins, or to the displacement amount corresponding to 1/N (N is an integer equal to 2 or more) of the maximum displacement amount. In a case where the tactile presentation device is a temperature sensation display, the presentation determination section 117 determines a temperature of e.g. an area of each object to be presented. For example, in a case where the temperature sensation display is capable of presenting a temperature from 10 degrees to 40 degrees, it is possible to determine a desired temperature to be presented within the temperature range.

That is, the presentation form determination section 117 determines, in a case where the pin display is used, the displacement amount of pins corresponding to an object area, and makes it possible to recognize a difference between the object area and an area other than the object area through tactile sensation. Further, the presentation form determination section 117 determines, in a case where the temperature sensation display is used, the temperature of the Peltier elements corresponding to an object area and makes it possible to recognize a difference between the object area and an area other than the object area recognizable through the warm and cold sensation.

The presentation control memory 118 is a storage device for storing information detected by the detection section 114, distance information acquired by the distance acquisition section 115, and so forth. The presentation control memory 118 stores necessary information, such as object types, the numbers of detected objects, coordinates of each object, object areas, and distances from objects.

The presentation controller 119 controls the operation of the tactile presentation section 130, described hereinafter, with reference to the contents stored in the presentation control memory 118. With this, the tactile presentation section 130 executes the following processing by using at least one information presentation unit of the temperature sensation display and the pin display, according to a presentation form determined by the presentation form determination section 117: The tactile presentation section 130 presents an image of an object area across a plurality of images in a state individually recognizable through tactile sensation for each object type detected by the detection section 114.

Further, the presentation controller 119 performs operation control of the tactile presentation section 130 to execute the following processing, by using at least one information presentation unit of the temperature sensation display and the pin display, according to a presentation form determined by the presentation form determination section 117: More specifically, the tactile presentation section 130 presents a plurality of images of object areas in a state recognizable through tactile sensation for each object type detected by the detection section 114 based on distance information acquired by the distance acquisition section 115. Similarly, by controlling the operation of the tactile presentation section 130 using the presentation controller 119, the following processing is executed using at least one information presentation unit of the temperature sensation display and the pin display, according to a presentation form determined by the presentation form determination section 117: More specifically, the tactile presentation section 130 presents a plurality of images of areas of objects in a state recognizable through tactile sensation based on distance information acquired by the distance acquisition section 115, on an object distance-by-object distance basis. Note that presentation for each distance includes not only presentation for each quite the same distance, but also presentation for each of predetermined divisional distance ranges. For example, presentation can be performed separately for a distance range not shorter than a distance A and shorter than a distance B and a distance range not shorter than the distance B and shorter than a distance C.

The tactile presentation section 130 can be realized e.g. by the pin display or the temperature sensation display. Note that any other type of the tactile presentation device can be used insofar as it is a device that can present the tactile sensation and achieve the purpose of the present invention. Further, the pin display is an information presentation unit based on unevenness feeling, and the temperature sensation display is an information presentation unit based on warm and cold sensation. Note that the information presentation unit based on warm and cold sensation and the information presentation unit based on unevenness feeling are also simply referred to as the warm and cold sensation-based information presentation unit and the unevenness feeling-based information presentation unit, respectively.

The pin display has pins corresponding to a plurality of pixels which are two-dimensionally arranged, respectively, and makes, for example, an object area and an area other than the object area recognizable through the unevenness feeling (tactile sensation) of the pins, by controlling the displacement amount of each pin. On the other hand, the temperature sensation display has Peltier elements corresponding to a plurality of pixels which are two-dimensionally arranged, respectively, and makes it possible, for example, to recognize an object area and an area other than the object area through the warm and cold sensation (tactile sensation) of the pins, by controlling the temperature of each Peltier element.

The tactile presentation section 130 presents information in a state recognizable through tactile sensation by using one information presentation unit of the temperature sensation display and the pin display, according to a presentation form determined by the presentation form determination section 117. Alternatively, the tactile presentation section 130 presents information in a state recognizable through tactile sensation, by using both of the temperature sensation display and the pin display. In a case where both of the temperature sensation display and the pin display are used, a various types of forms are considered. For example, the object type is divided into a person and an object other than the person, and information of the respective areas is presented in a state recognizable through tactile sensation. For example, the information of a person area is presented by the pin display, whereas the information of an area other than the person area is presented by the temperature sensation display. With this, a visually handicapped person who mainly intends to grasp persons can quickly grasp e.g. the respective sizes of person areas and the number of the person areas through tactile sensation of the pins of the pin display.

Further, the presentation form includes one in which information is presented using the pin display with respect to part at and around the center of one image and also information is presented using the sensation display with respect to the other part of the one image. This enables a visually handicapped person to quickly grasp e.g. an area of an object existing at or around the center of the image, the number of objects, and the size of the object through tactile sensation of the pins of the pin display. On the other hand, the visually handicapped person is enabled to grasp areas of objects, the number of the objects, the size of each object and the like, in the part of the image other than the center part of the image through the warm and cold sensation of the Peltier elements of the temperature sensation display. Basically, an interest in an object existing at or around the image center is higher than an interest in part other than the image center. Therefore, by presenting the information by using different displays separately with respect to an object existing at or around the image center and an object existing in part other than at and around the center part, the visually handicapped person can quickly grasp the information presented with respect to the object existing at or around the image center. However, the form of presenting information by using both of the displays is not limited to these.

The operation of the detected information-presenting section 131 is controlled by the presentation controller 119 to present information of an object which can be presented by the tactile presentation section 130 or information of a presented object in a state recognizable by using braille or voice. Specifically, the detected information-presenting section 131 presents a plurality of object area images on an object type-by-object type basis based on distance information. The detected information-presenting section 131 further presents a plurality of object area images on an object distance-by-object distance basis, based on the distance information. These presentation operations are performed in a state recognizable by using braille or voice.

The operation of the detected information-presenting section 131 is controlled by the presentation controller 119 to present at least one of object information detected by the detection section 114 and distance information acquired by the distance acquisition section 115 by using a braille display and/or voice. Specifically, the information presented by the detected information-presenting section 131 includes e.g. object types, the numbers of detected objects, coordinates of each object, object areas, and object distances. These information items are presented to a user (visually handicapped person) by using the braille display and/or voice. Here, presentation using voice is performed, for example, by explaining by voice, that objects A to N exist, that the objects A to N are near, far, or at an intermediate distance, and that the types of the objects A to N are a person, a dog, a vehicle, or the like.

The system controller 140 controls the overall operation of the image information-presenting apparatus 100. A processor, not shown, such as a central processing unit (CPU) or a digital signal processor (DSP), executes programs stored in the nonvolatile memory 142, described hereinafter, whereby processes of the present embodiment, described hereinafter, and the components shown in FIG. 1 are realized.

The operation section 141 is operating means for providing a variety of operation instructions to the system controller 140. The operation section 141 can use a known technique, such as an input operation using a keyboard and a voice input operation using voice recognition. Further, the configuration can be such that object types detected by the detection section 114 are each presented by switching therebetween according to an operation of the operation section 141, or such that a switching section is provided which switches between items of distance information acquired by the distance acquisition section 115, for presentation.

The nonvolatile memory 142 is an electrically erasable and recordable memory and can be implemented e.g. by an electrically erasable programmable read-only memory (EEPROM). The nonvolatile memory 142 stores constants for operation of the system controller 140, programs, and so forth, in a nonvolatile state. The programs stored in the nonvolatile memory 142 are used to execute a variety of processes in the present embodiment as described above.

The system memory 143 is implemented e.g. by a RAM. The system memory 143 stores constants for the operation of the system controller 140, variables, and so forth. When the system controller 140 executes a program, the system controller 140 loads the program read from the nonvolatile memory 142 into the system memory 143 and executes the loaded program. With this, the processes in the embodiments and the components shown in FIG. 1 are realized.

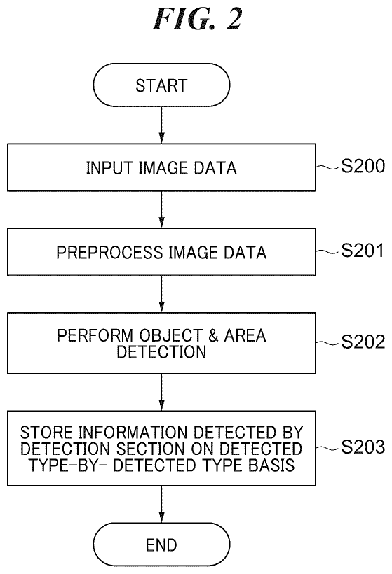

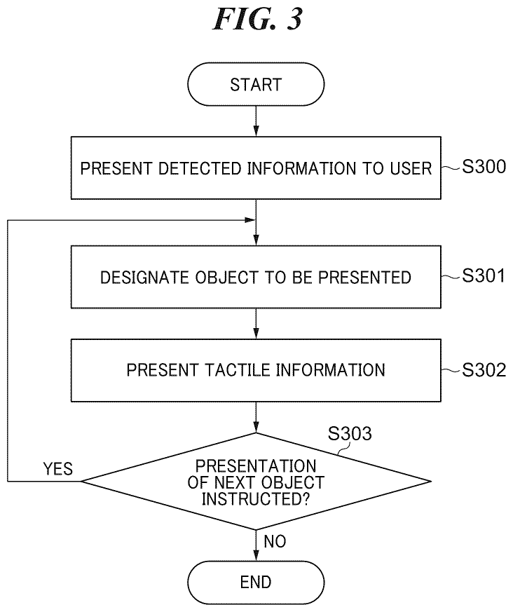

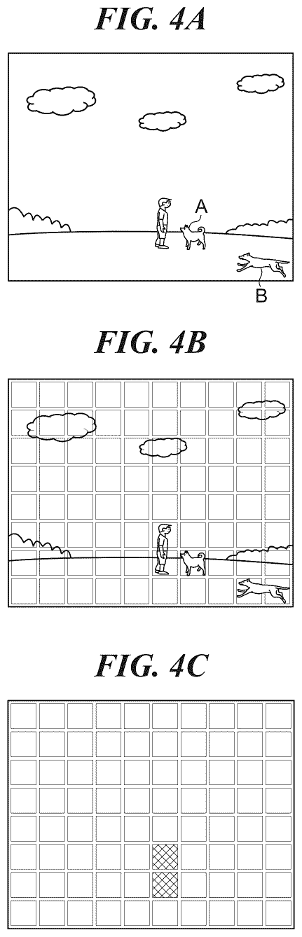

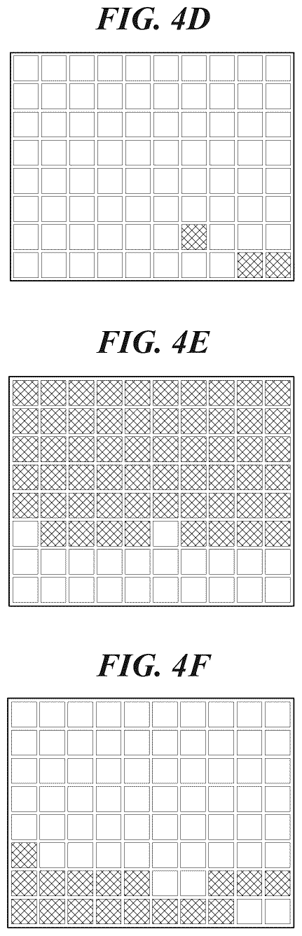

Next, the processes in the first embodiment will be described with reference to FIGS. 2 and 3. Note that in the description of the processes in the first embodiment, the description is given also with reference to explanatory diagrams of the image of input/output, shown in FIGS. 4A to 4F. The first embodiment is characterized in that the detection section 114 detects a type of an object, a position of the object, a size of the object, and an area of the object, and the like, and presents the detected information on the tactile presentation device, such as a pin display, in a state dividing the detected information a plurality of times (into a plurality of images) on an object type-by-object type basis.

An object area detection process will be described with reference to FIG. 2. First, in a step S200, the image input section 111 writes input image data into the image memory 112. Next, in a step S201, the preprocessing section 113 reads out the image data from the image memory 112, performs image processing suitable for the object area detection processing to be executed by the detection section 114, and writes the image data after being subjected to the image processing in the image memory 112.

Next, in a step S202, the detection section 114 reads out the image data from the image memory 112 and performs the object area detection processing. That is, the detection section 114 detects one or more predetermined areas of objects, based on the read image data. The detection section 114 detects a position of each object, a size of the object, and a type of the object (such as a vehicle, an airplane, a bird, an insect, a human body, a head, a pupil, a cat, a dog, a ball, or the like) in the image data for each detected object area.

Then, in a step S203, the detection section 114 writes the detected information (such as the object position, the object size, and the object type) into the object information memory 116. More specifically, as described above, the detection section 114 writes, into the object information memory 116, object data in which the object position, the object size, the object type, and the reliability of each type in the image data are associated with each other for each detected area.

Next, a tactile sensation presentation process will be described with reference to FIG. 3. First, in a step S300, the detected information-presenting section 131 presents the detected information written in the object information memory 116 in the step S203 in FIG. 2. The detected information to be presented is information of the object type, the number of detected objects of each object type, the detected position (coordinates) of the object, the object area, and so forth. The detected information-presenting section 131 presents the information by using the braille display and/or voice, and hence a visually handicapped person can grasp the presented information.

Next, in a step S301, out of the detected information presented in the step S300, the user designates an object desired to be presented via the operation section 141. For example, the user designates the object e.g. by keyboard input or voice input using voice recognition.

Next, in a step S302, the tactile presentation section 130 presents tactile sensation information. Then, in a step S303, if it is determined by the system controller 140 that the user does not operate the operation section 141 and does not instruct presentation of the next object (NO), the process is terminated. On the other hand, in the step S303, if it is determined by the system controller 140 that the user has operated the operation section 141 and instructed presentation of the next object (YES), the system controller 140 returns to the step S301 and continues the process.

Note that although in the presentation process in FIG. 3, the user designates a type of an object to be presented, types of detected objects can be presented through tactile sensation in a predetermined order, and the detected information can be automatically presented. As the predetermined order, the order of the Japanese syllabary of the object name, the order of the object size, or the like, can be set. At this time, as for an instruction for switching the presentation from the information being presented to presentation of another object type, the time taken for recognition through tactile sensation is different between individuals, and hence it is preferable to enable a user himself/herself to provide the switching instruction.

In the first embodiment, the detection section 114 detects a type of an object and an area of this object based on image data input by the image input section 111. Further, the presentation form determination section 117 determines a presentation form in the tactile sensation presentation area corresponding to the object area detected based on the type of the detected object. Further, the tactile presentation section 130 presents a plurality of images of the object areas for each type of the detected objects by using at least one information presentation unit of the temperature sensation display and the pin display in a state recognizable through tactile sensation, according to the determined presentation form.

Further, the presentation form determination section 117 can be configured to further include a changing section that changes a degree of presentation in a state recognizable through tactile sensation according to an object type detected by the detection section 114 for at least one information presentation unit of the temperature sensation display and the pin display. In a case where one of the temperature sensation display and the pin display is used, the changing section changes the degree of presentation in a state recognizable through tactile sensation according to an object type detected by the detection section 114 for the one display. Further, in a case where both of the displays are used, the changing section changes the degree of presentation in a state recognizable through tactile sensation according to an object type detected by detected by the detection section 114 for both of the displays. That is, this changing section changes the pin displacement amount on the pin display and the temperature of the Peltier elements on the temperature sensation display according to a type of a detected object.

Next, the outline of the image of input/output will be described with reference to FIGS. 4A to 4F. FIG. 4A shows an input image. In the input image shown in FIG. 4A, a person and a dog A are opposed to each other in the vicinity of the center of the image in the nature in which the sky and the lawn grass spread. Further, in the image shown in FIG. 4A, a dog B in the lower right part of the image is running from the near toward the person positioned in the vicinity of the center. The detection section 114 detects the person, the dog A, the dog B, the sky, and the lawn grass, as the object types, and the areas of the objects, with respect to this example of the input image.

According to the description based on the first embodiment, the person and the dog A in FIG. 4A are the objects existing at substantially the same distance. However, even when the distance information is the same, presentation considering the object type is performed, and hence the person and the dog A are separately presented, and therefore, a visually handicapped person can identify these objects.

FIG. 4B is an explanatory diagram showing a correspondence relation between the input image and the pixels of the temperature sensation display. Specifically, FIG. 4B shows the correspondence relation between the input image and the temperature sensation display having a resolution of 10 pixels in the horizontal direction and 8 pixels in the vertical direction. FIG. 4C shows a case where the area of the person is presented in the input image. Referring to FIG. 4C, a hatched part is the area of the person in the input image. By changing the presentation temperature between the hatched part and part other than the hatched part, the user can recognize the area (position) of the person.

FIG. 4D shows a case where the areas of the dog A and the dog B are presented in the input image. Hatched part in FIG. 4D is the areas of the dog A and the dog B in the input image. By changing the presentation temperature between the hatched part and part other than the hatched part, the user can recognize the respective areas (positions) of the dog A and the dog B. Similarly, FIG. 4E shows a case where the area of the sky is presented in the input image, and FIG. 4F shows a case where the area of the lawn grass is presented in the input image.

As described above, based on the information of the type of each object in the input image, the image information-presenting apparatus 100 according to the first embodiment can present the position of the object, the size of the object, and so forth, on an object type-by-object type basis. With this, even when the input image is e.g. a photograph having a lot of information, a visually handicapped person can identify the position of each object, the size of the object, and so forth, on an object type-by-object type basis in the input image.

In the first embodiment, the image input section 111 inputs e.g. a photographic image, and the detection section 114 detects an object area and type information (metadata) on an object type-by-object type basis based on the detected information. The tactile presentation section 130 time-divisionally presents a plurality of image data items stored in the presentation control memory 118 on an object type-by-object type basis. With this, the position of each object, the size of the object, and so forth are presented on an object type-by-object type basis, whereby even when the input image is e.g. a photograph having a lot of information, a visually handicapped person can identify the position of the object, the size of the object, and so forth, for each type of the object included in the photograph, and hence the visually handicapped person can enjoy photograph appreciation.

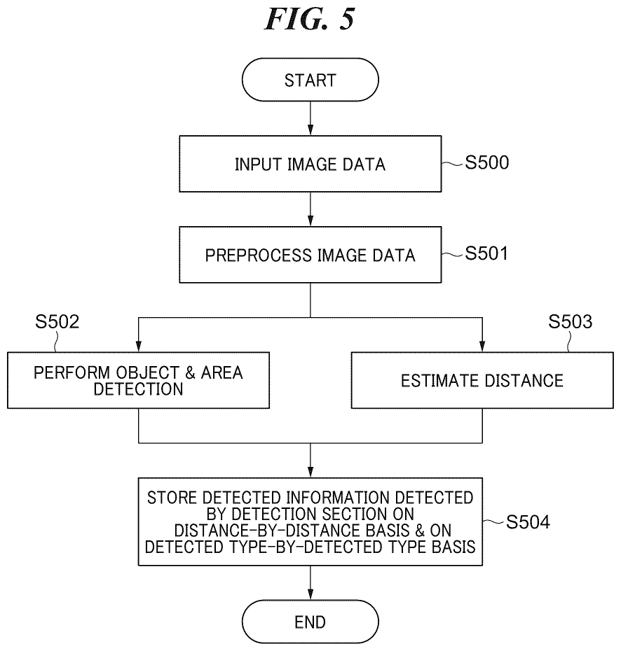

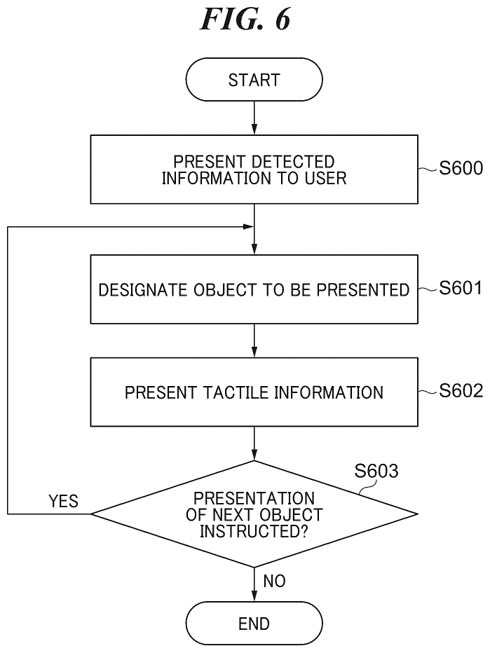

Next, processes in a second embodiment will be described with reference to FIGS. 5 and 6. In the second embodiment, a type of each object, a position of the object, a size of the object, areas, and so forth are detected by an object area detection process performed by the detection section 114. Further, the distance acquisition section 115 acquires distance information, and objects are presented, according to the tactile presentation device, such as the pin display, a plurality of times, on an object distance-by-object distance basis, and on an object type-by-object basis.

An object area detection process will be described with reference to FIG. 5. Note that processing operations in steps S500, S501, and S502 are the same as the steps S200, S201, and S202 in FIG. 2 described in the first embodiment, and hence redundant description is omitted.

In a step S503, the distance acquisition section 115 reads out image data stored in the image memory 112 and estimates distance information based on the read image data. In a case where the distance information is directly input together with the image data, the input distance information is directly used without estimating the distance information.

Then, in a step S504, the system controller 140 writes the detected information (object types, object positions, object sizes, and so forth) detected by the detection section 114 into the object information memory 116 in a state associated with the distance information acquired by the distance acquisition section 115. Specifically, the system controller 140 writes the information detected by the detection section 114 in the object information memory 116 for each object type detected by the detection section 114 and for each distance information (each distance) acquired by the distance acquisition section 115.

Next, a tactile presentation process will be described with reference to FIG. 6. Note that processing operations in steps S601, S602, and S603 are the same as the steps S301, S302, and S303 in FIG. 3 described in the first embodiment, and hence redundant description is omitted. Only a step S600 is different from the first embodiment.

In the step S600, the detected information-presenting section 131 presents the detected information with which the distance information is associated, which is written in the object information memory 116, to the user. The detected information presented to the user is e.g. the type of each object, the number of detected objects of each object type, detected objects coordinates, object area information, and distances from the object. At this time, the information is presented to the user by using e.g. the braille display and/or voice.

In the second embodiment, the object type associated with the distance information is presented. Therefore, it is possible to present the information such that even when objects of the same object type are detected, the user can grasp that the objects are different in distance information. Thus, the image information-presenting apparatus 100 according to the second embodiment presents e.g. the position of each object, the size of the object, and so forth, on distance information-by-distance information basis and on object type-by-object type basis, based on the object type information and the distance information in the input image. Therefore, even when the input image is e.g. a photograph having a lot of information, a visually handicapped person can grasp the position of the object, the size of the object, and the like, together with added sensation of the depth for each of types of objects in the input image. Since the information of the depth direction is added, the visually handicapped person can three-dimensionally grasp and identify the object.

Further, the example of the second embodiment will be described with reference to FIGS. 4A to 4F. Assuming that distances between the sky, the person, and the dog B in FIG. 4A are expressed by KA, KB, and KC, respectively, KA>KB>KC holds. Even when the distances between the objects are thus different, according to the distance information, object areas are presented on an object type-by-object type basis. Therefore, since the object area is presented on distance information-by-distance information basis and on a detected type-by-detected type basis, by individually presenting image data of each object using a plurality of images, the visually handicapped person can more easily grasp each object in the input image, the position (area) of the object, the size of the object, and so forth.

In the second embodiment, object areas (images) and type information/distance information (metadata) are detected based on distance information acquired by the distance acquisition section 115 and object types detected by the detection section 114. The tactile presentation section 130 time-divisionally presents a plurality of image data items stored in the presentation control memory 118 on an object type-by-object type basis and on distance information-by-distance information basis. With this, the visually handicapped person can identify the position of each object appearing in the photograph and the size of the object, on an object type-by-object basis, according to the distance, and hence the visually handicapped person can easily enjoy photograph appreciation.

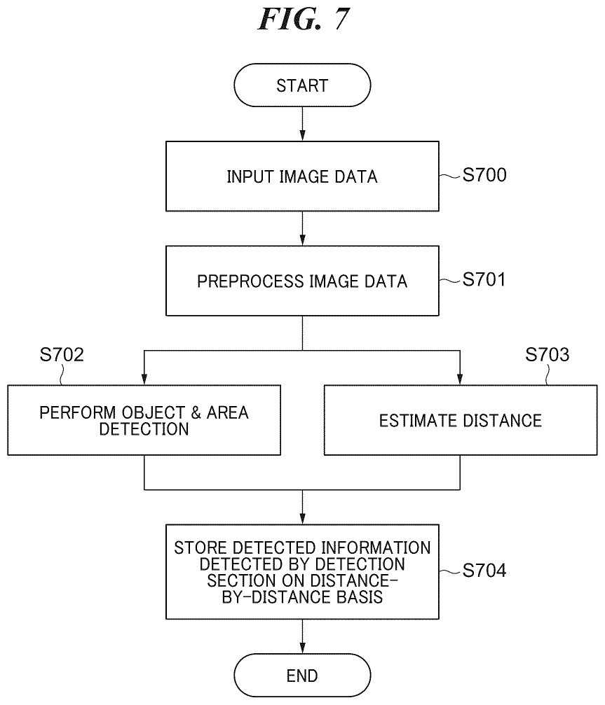

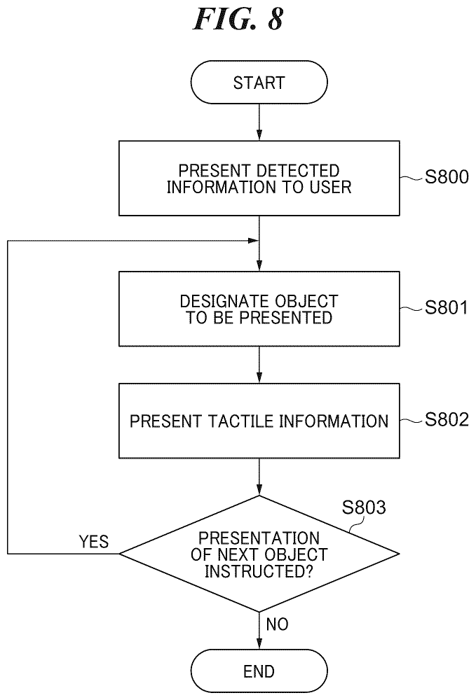

Next, processes performed in a third embodiment will be described with reference to FIGS. 7 and 8. In the third embodiment, the detection section 114 detects a type of each object, a position of the object, a size of the object, an object area, and so forth. Further, the distance acquisition section 115 acquires distance information. Further, the tactile presentation section 130 presents information detected by the detection section 114 divisionally a plurality of times on acquired distance information-by-acquired distance information.

Processing operations in steps S700, S701, S702, and S703 in FIG. 7 are the same as the steps S500, S501, S502, and S503 in FIG. 5 described in the second embodiment, and hence redundant description is omitted. Only a step S704 is different from the second embodiment.

In the step S704, the detected information (object types, object positions, object sizes, and so forth) detected by the detection section 114 is written into the object information memory 116 for each distance information acquired by the distance acquisition section 115.

A tactile presentation process in the third embodiment will be described with reference to FIG. 8. Processing operations in steps S801, S802, and S803 in FIG. 8 are the same as the steps S601, S602, and S603 in FIG. 6 described in the second embodiment, and hence redundant description is omitted.

Only a step S800 is different from the second embodiment.

In the step S800, the detected information-presenting section 131 presents the information detected by the detection section 114, which is written in the object information memory 116 on distance information-by-distance information basis, to the user, in a state recognizable by using e.g. the braille display and/or voice. The detected information to be presented is the contents of each object type, the number of detected objects of each object type, the detected object coordinates, the object area information, the object distance information, and so forth. In the third embodiment, the object is presented on distance information-by-distance information basis, and hence even when detected objects are different in type, it is possible to simultaneously present the information of the objects to the visually handicapped person if the objects are the same in distance information.

As described above, the image information-presenting apparatus 100 according to the third embodiment presents object areas, object positions, object sizes, and so forth, which are information detected by the detection section 114, on distance information-by-distance information basis, based on the object type information and the acquired distance information in the input image. In doing this, the tactile presentation section 130 presents the detected information (object areas and the like) detected by the detection section 114 divisionally a plurality of times on acquired distance information-by-acquired distance information basis.

Therefore, even when the input image is e.g. a photograph having a lot of information, the visually handicapped person can grasp the object position, the object size, and so forth, together with added sensation of each of objects in the input image. As a result, since the depth direction of each object is added, the visually handicapped person can three-dimensionally grasp each object through tactile sensation.

In the third embodiment, object areas (images) and the type information/distance information (metadata), which are detected by the detection section 114, are presented based on the distance information acquired by the distance acquisition section 115. The tactile presentation section 130 time-divisionally presents the plurality of image data items stored in the presentation control memory 118 based on the distance information. With this, the visually handicapped person can identify the position, size and so forth of each of objects included in a photograph, on distance-by-distance information, and therefore, the visually handicapped person can easily enjoy photograph appreciation.

Next, a process in a fourth embodiment will be described. The fourth embodiment is characterized not in that detected objects are presented on distance information-by-distance information basis as described in the third embodiment, but in that the form of presentation through tactile sensation is changed according to the acquired distance information.

For example, in a case where the information is presented by the temperature sensation display, the temperature is set to be higher as information indicated by the distance information is closer, and set to be lower as the information indicated by the distance information is farther. Alternatively, opposite to the above, the temperature is set to be lower as the information indicated by the distance information is closer, and set to be higher as the information indicated by the distance information is farther. With such configuration, the warm and cold sensation is changed according to a distance from an object, and hence the visually handicapped person can easily grasp a distance from an object through the warm and cold sensation.

Further, in the presentation form in the pin display, the pin displacement amount is set to be larger as the distance indicated by the distance information is closer and is set to be smaller as the distance indicated by the distance information is farther. Alternatively, opposite to the above, the pin displacement amount is set to be smaller as the distance indicated by the distance information is closer and is set to be larger as the distance indicated by the distance information is farther. With such configuration, the unevenness feeling of the pins is changed according to a distance from an object, and hence the visually handicapped person can easily grasp a distance from an object through the unevenness feeling.

As described above, the image information-presenting apparatus 100 according to the fourth embodiment changes the form of presenting an object on distance information-by-distance information basis, based on the object type information and the acquired distance information in the input image. Then, the object position, the object size, and so forth, which are the information detected by the detection section 114, are presented. With this, even when the input image is e.g. a photograph having a lot of information, the visually handicapped person can also grasp the object position, the object size, and so forth, together with added sensation of depth for each of objects in the input image, on an object type-by-object basis.

Next, a process in a fifth embodiment will be described. In the fifth embodiment, objects are presented not on an object type-by-object type basis as in the first embodiment, but the degree of presentation of an object in a state recognizable through tactile sensation is changed according to an object type.

For example, in presentation using the temperature sensation display, the temperature is set to be high for an object type A, set to be low for an object type C, and set to an intermediate temperature for an object type B. Alternatively, opposite to the above, the temperature is set to be low for the object type A and set to be high for the object type C. With such configuration, the warm and cold sensation is changed according to an object type, and hence the visually handicapped person can grasp the type of the object through the warm and cold sensation.

Further, in presentation using the pin display, the pin displacement amount is set to the maximum amount for the object type A, set to the minimum amount for the object type C, and set to an intermediate amount between the maximum amount and the minimum amount for the object type B. Alternatively, opposite to the above, the pin displacement amount is set to the minimum amount for the object type A, and set to the maximum amount for the object type C. With such configuration, the unevenness feeling of the pins is changed according to an object type, and hence the visually handicapped person can grasp the type of the object through the unevenness feeling of the pins.

As described above, the image information-presenting apparatus 100 according to the fifth embodiment changes the degree of presentation of an object, on an object type-by-object type basis, based on the type information of an object in the input image and presents the object position, the object size, and so forth. With this, even when the input image is e.g. a photograph having a lot of information, the visually handicapped person can grasp the object position, the object size, and so forth for each of types of objects in the input image.

According to the second to fifth embodiments, the detection section 114 detects object types and object areas based on image data input by the image input section 111, and the distance acquisition section 115 acquires the distance information based on the input image data. The presentation form determination section 117 determines the form of presenting tactile presentation areas corresponding to detected object areas based on the object types detected by the detection section 114 and the distance information acquired by the distance acquisition section 115.

Further, the tactile presentation section 130 performs the following processing using at least one information presentation unit of the temperature sensation display and the pin display according to the presentation form determined by the presentation form determination section 117: The tactile presentation section 130 presents a plurality of images of object areas detected by the detection section 114 on an object type-by-object type basis based on the distance information acquired by the distance acquisition section 115 in a state recognizable through tactile sensation.

Further, the tactile presentation section 130 performs the following processing using at least one information presentation unit of the temperature sensation display and the pin display according to the presentation form determined by the presentation form determination section 117: The tactile presentation section 130 present a plurality of images of areas of objects detected by the detection section 114, on object distance-by-object distance basis, in a state recognizable through tactile sensation, based on the distance information acquired by the distance acquisition section 115.

Further, in the other configuration, the distance acquisition section 115 acquires the distance information based on image data input by the image input section 111, and the presentation form determination section 117 determines the presentation form of presenting tactile presentation areas based on the distance information acquired by the distance acquisition section 115.

Further, the presentation form determination section 117 further includes the changing section that changes the degree of presentation in a state recognizable through tactile sensation based on the distance information acquired by the distance acquisition section 115 for at least one information presentation unit of the temperature sensation display and the pin display. In a case where one of the temperature sensation display and the pin display is used, the changing section changes the degree of presentation in a state recognizable through tactile sensation based on the distance information acquired by the distance acquisition section 115 for the one of the displays.

Further, in a case where both of the displays are used, the changing section changes the degree of presentation in a state recognizable through tactile sensation based on the distance information acquired by the distance acquisition section 115 for both of the displays. That is, the changing section changes the pin displacement amounts on the pin display and the temperature of the Peltier elements on the temperature sensation display, based on the distance information acquired by the distance acquisition section 115.

In the above-described embodiments, the description is given of the example that objects detected by the detection section 114 are presented through tactile sensation. In a case where the size of a detected object is small, this object can become noise, and hence processing e.g. for masking objects smaller than a predetermined threshold can be performed. Objects of a type to be preferentially detected (priority detection objects) are not subjected to this processing. By thus configuring the image information-presenting apparatus 100 such that a masking section is included for masking objects of which areas are smaller than a predetermined threshold value and which are not priority detection objects, it is possible to execute reduction of noise and like other processing.

Further, although in the above-described embodiments, the description is given of the example that the tactile presentation is performed by using the pin display or the temperature sensation display, this is not limitative. For example, the object area can be presented by presenting the unevenness feeling using the pin display, and the distance information can be presented by presenting the warm and cold sensation using the temperature sensation display at the same time. Alternatively, opposite to the above, the tactile presentation can be performed such that the distance information is presented by presenting the unevenness feeling using the pin display, and the object areas are presented by presenting the warm and cold sensation using the temperature sensation display at the same time.

Further, the distance information acquired by the distance acquisition section 115 can be presented in a state recognizable through the warm and cold sensation by using the temperature sensation display, and the object areas detected by the detection section 114 can be presented in a state recognizable through the unevenness feeling by using the pin display. Alternatively, opposite to the above, the distance information acquired by the distance acquisition section 115 can also be presented in a state recognizable through the unevenness feeling by using the pin display, and the object areas detected by the detection section 114 can be presented in a state recognizable through the warm and cold sensation by using the temperature sensation display.

Further, the present invention can also be applied to an image of a three-dimensional virtual space, such as a metaverse. The virtual space of the metaverse is configured such that the three-dimensional virtual space of 360 degrees in a horizontally circumferential direction is grasped by using dedicated goggles, dedicated glasses, or the like. Therefore, as for the image data of the metaverse, three-dimensional image data obtained via the dedicated goggles, the dedicated glasses, or the like is input by the image input section 111. At this time, 360 degrees are divided into a plurality of regions, the pin display or the temperature sensation display is associated with each divided region, and the information of 360 degrees is presented by a plurality of pin displays or temperature sensation displays in a state recognizable through tactile sensation. At this time, the type of the display to be associated with the divided region can be changed. For example, the pin display can be associated with the region of 180 degrees in the front direction, and the temperature sensation display can be associated with the region of 180 degrees in the rear direction.

Further, the present invention can be applied to a virtual space in which the dedicated goggles, the dedicated glasses, or the like are not used. The information can be presented by inputting image data of this virtual space to the image input section 111 and performing the processes described in the above-described embodiments. In this case, since the dedicated goggles, the dedicated glasses, or the like are not used, the information is not a real three-dimensional image, but the same presentation as the above-described information presentation can be performed. Also in this case, 360 degrees in the horizontally circumferential direction can be divided into a plurality of regions, and the pin display or the temperature sensation display can be associated with each divided region, whereby the information of 360 degrees can be presented by a plurality of pin displays or temperature sensation displays in a state recognizable through tactile sensation.

The image information-presenting apparatus 100 except for the tactile presentation section 130 realized by the temperature sensation display and the pin display can be realized e.g. by one personal computer (PC) including a compact disc (CD) drive or a card reader. Image data is recorded in a CD or a card, and the PC reads out the image data. The PC and the pin display are connected such that necessary information can be communicated by near-field wireless communication. In this case, for example, a communication system using Bluetooth (registered trademark) can be employed. Further, the image information-presenting apparatus 100 except the tactile presentation section 130 includes a transmission section.

The presentation form information is transmitted to the pin display by this transmission section. A central processing unit (CPU) included in the pin display controls the displacement amounts of pins which are two-dimensionally arranged based on the received presentation form information. The presentation form determination section 117 calculates a displacement amount of each pin based on the information detected with respect to the image data, such as a photograph, and transmits the calculated displacement amount of each pin to the pin display as the presentation form information.

In response to this, the CPU of the pin display controls the displacement amount of each pin based on the received presentation form information. With this, a plurality of visually handicapped persons can share the information, such as the object types and the object areas, with respect to the same image data. The same process can also be performed for the temperature sensation display.

That is, the image information-presenting apparatus 100 is configured by connecting an image processing apparatus (corresponding to the image processor 110) and a display (such as the pin display and the temperature sensation display) such that necessary information can be communicated by wireless communication. The image processing apparatus includes the image input section 111 and the detection section 114 that detects types of object and areas of the objects based on image data input by the image input section 111.

The image processing apparatus further includes the presentation form determination section 117 that determines the form of presenting tactile presentation areas corresponding to the object areas detected by the detection section 114. The image processing apparatus further includes the transmission section that transmits the presentation form determined by the presentation form determination section 117 to the display.

On the other hand, the display is configured such that members including the pins or the Peltier elements are two-dimensionally arranged, and information is presented in a state recognizable through tactile sensation by variably controlling a physical amount which changes in the members, and the display includes a reception section that receives the presentation form determined by the presentation form determination section 117. The display further includes a presentation section that presents object areas in a state recognizable through tactile sensation by variably controlling physical amounts of the members corresponding to the tactile presentation area, based on the presentation form determined by the presentation form determination section 117 and received by the reception section.

Therefore, on the display side, it is possible to grasp object areas detected by the detection section 114 through tactile sensation by variably controlling the physical amount of each member corresponding to the tactile presentation area based on the received presentation form determined and transmitted by the image processing apparatus side. Here, the control to change the physical amount refers to control to change the pin displacement amounts in a case where the pin display is used, and control to change temperatures of the Peltier elements in a case where the temperature sensation display is used. That is, the control to change the physical amounts of the members refers to control to change a variety of amounts, a change of which can be grasped through tactile sensation when some change is applied to the members which are two-dimensionally arranged, even in a display other than the-above mentioned displays.

The image information-presenting apparatus 100 except the tactile presentation section 130 realized by the temperature sensation display and the pin display can also be realized by a mobile terminal, such as a smartphone or a tablet terminal. Information (presentation control information) obtained by performing the processes in the above-described embodiments on a photograph captured by the mobile terminal is transmitted to the pin display. The presentation control information is transmitted to the pin display by using the Bluetooth (registered trademark) function and the like of the mobile terminal. The CPU included in the pin display controls the displacement amounts of pins, which are two-dimensionally arranged, based on the received presentation control information.

To realize this, dedicated programs for enabling execution of the processes in the embodiments can be downloaded e.g. from a specific site and is installed in the mobile terminal. Thus, it is possible to share the object types, the object areas, and so forth, detected with respect to image data photographed by one visually handicapped person using a mobile terminal, between a plurality of visually handicapped persons. The same process can also be performed for the temperature sensation display.

The image information-presenting apparatus is provided which presents information in a state recognizable through tactile sensation and enables a visually handicapped person to grasp an area of an object, and so forth, for each type of the object and/or each distance of the object in image data, such as a photograph.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application NO. 2023-117391 filed Jul. 19, 2023, which is hereby incorporated by reference herein in its entirety.

What is claimed is:

1. An image processing apparatus comprising:
an image input section configured to input image data;
a detection section configured to detect object types of objects and object areas of the objects based on the image data input by the image input section; and
a presentation form determination section configured to determine a presentation form of presenting a tactile presentation area corresponding to each object area detected by the detection section, for each object type detected by the detection section.

2. The image processing apparatus according to claim 1, further comprising a first presentation section configured to present a plurality of images of object areas in a state recognizable through tactile sensation for each object type detected by the detection section, by using at least one information presentation unit of an information presentation unit based on warm and cold sensation and an information presentation unit based on unevenness feeling, according to the presentation form determined by the presentation form determination section.

3. The image processing apparatus according to claim 2, wherein the presentation form determination section includes a changing section that changes a degree of presenting information in a state recognizable through tactile sensation for each object type detected by the detection section for at least one information presentation unit of the information presentation unit based on the warm and cold sensation and the information presentation unit based on the unevenness feeling.

4. The image processing apparatus according to claim 1, further comprising a distance acquisition section configured to acquire distance information based on the image data input by the image input section, and
wherein the presentation form determination section includes a presentation form determination section that determines the presentation form of presenting the tactile presentation area corresponding to each object area detected by the detection section based on each object type detected by the detection section and the distance information acquired by the distance acquisition section.

5. The image processing apparatus according to claim 4, further comprising a second presentation section configured to present a plurality of images of object areas in a state recognizable through tactile sensation for each object type detected by the detection section based on the distance information acquired by the distance acquisition section by using at least one information presentation unit of the information presentation unit based on the warm and cold sensation and the information presentation unit based on the unevenness feeling according to the presentation form determined by the presentation form determination section.

6. The image processing apparatus according to claim 4, further comprising a third presentation section configured to present a plurality of images of object areas in a state recognizable through tactile sensation for each object distance detected by the detection section based on the distance information acquired by the distance acquisition section by using at least one information presentation unit of the information presentation unit based on the warm and cold sensation and the information presentation unit based on the unevenness feeling according to the presentation form determined by the presentation form determination section.

7. The image processing apparatus according to claim 4, further comprising a distance area presentation section configured to present the distance information acquired by the distance acquisition section in a state recognizable through the warm and cold sensation by using the information presentation unit based on the warm and cold sensation and present the object areas detected by the detection section in a state recognizable through the unevenness feeling by using the information presentation unit based on the unevenness feeling, or present the distance information acquired by the distance acquisition section in a state recognizable through the unevenness feeling by using the information presentation unit based on the unevenness feeling and present the object areas detected by the detection section in a state recognizable through the warm and cold sensation by using the information presentation unit based on the warm and cold sensation.

8. The image processing apparatus according to claim 1, further comprising an information presentation section configured to present detected information of the objects detected by the detection section by using a braille display and/or voice.

9. The image processing apparatus according to claim 1, further comprising a masking section configured to mask, in a case where an area of an object detected by the detection section is smaller than a predetermined threshold value and the detected object is not a priority detection object which is a predetermined object to be preferentially detected, the corresponding object.

10. The image processing apparatus according to claim 1, further comprising a switching section configured to switch between the object types detected by the detection section, for presentation, according to a user's operation of an operation section.

11. The image processing apparatus according to claim 2, wherein the information presentation unit based on the warm and cold sensation is a temperature sensation display, and the information presentation unit based on the unevenness feeling is a pin display.

12. The image processing apparatus according to claim 1, further comprising an information presentation unit that is capable of presenting image information through tactile sensation based on the presentation form determined by the presentation form determination section.

13. The image processing apparatus according to claim 1, wherein the image processing apparatus can be connected to an image information-presenting apparatus including an information presentation unit capable of presenting image information through tactile sensation,
the image processing apparatus further comprising a transmission section that transmits the presentation form determined by the presentation form determination section to the information presentation unit.

14. An image processing apparatus comprising:
an image input section configured to input image data;
a distance acquisition section configured to acquire distance information based on image data input by the image input section; and
a presentation form determination section configured to determine a presentation form of presenting a tactile presentation area on a distance-by-distance basis, based on the distance information acquired by the distance acquisition section.

15. The image processing apparatus according to claim 14, wherein the presentation form determination section includes a changing section that changes a degree of presenting information in a state recognizable through tactile sensation, on a distance-by-distance basis, according to the distance information acquired by the distance acquisition section for at least one information presentation unit of an information presentation unit based on warm and cold sensation and an information presentation unit based on unevenness feeling.

16. The image processing apparatus according to claim 14, further comprising an information presentation section configured to present the distance information acquired by the distance acquisition section by using a braille display and/or voice.

17. An image information-presenting apparatus that can be connected to an image processing apparatus, comprising:
an information presentation unit that includes at least ones of pins and Peltier elements two-dimensionally arranged, and is configured to be capable of presenting information through tactile sensation by variably controlling a physical amount which changes in the members; and
a reception section configured to receive an instruction of a presentation form provided by the information presentation unit,
wherein the information presentation unit presents an image to be presented, on an object type-by-object basis, based on the presentation form received by the reception section.

18. An image information-presenting system comprising:
an image input section configured to input image data;
a detection section configured to detect object types of objects and object areas of the objects based on the image data input by the image input section;
a presentation form determination section configured to determine a presentation form of presenting a tactile presentation area corresponding to each object area detected by the detection section based on the object types detected by the detection section; and
an information presentation unit that includes at least ones of pins and Peltier elements two-dimensionally arranged, and is configured to be capable of presenting information through tactile sensation by variably controlling a physical amount which changes in the members,
wherein the information presentation unit presents images to be presented, on an object type-by-object basis, based on the presentation form determined by the presentation form determination section.

19. A method of controlling an image processing apparatus, comprising:
inputting image data;
detecting object types of objects and object areas of the objects based on the image data input by said inputting; and
determining a presentation form of presenting a tactile presentation area corresponding to each object area detected by said detecting for each of the object types detected by said detecting.

20. A method of controlling an image processing apparatus, comprising:
inputting image data;
acquiring distance information based on the image data input by said inputting; and
determining a form of presenting a tactile presentation area, on a distance-by-distance, based on the distance information acquired by said acquiring.

21. A non-transitory computer-readable storage medium storing a program for causing a computer to execute a method of controlling an image processing apparatus,
wherein the method comprises:
inputting image data;
detecting object types of objects and object areas of the objects based on the image data input by said inputting; and
determining a presentation form of presenting a tactile presentation area corresponding to each object area detected by said detecting for each of the object types detected by said detecting.

22. A non-transitory computer-readable storage medium storing a program for causing a computer to execute a method of controlling an image processing apparatus,
wherein the method comprises:
inputting image data;
acquiring distance information based on the image data input by said inputting; and
determining a form of presenting a tactile presentation area, on a distance-by-distance, based on the distance information acquired by said acquiring.
